(19) United States
(12) Patent Application Publication
(10) Pub. No.: US 2012/0191444 A1
(43) Pub. Date: Jul. 26, 2012

(54) SIMULATION DEVICE, SIMULATION METHOD, AND COMPUTER PROGRAM THEREFOR

(75) Inventor: Takeaki SUGIMURA, Kanagawa (JP)

(73) Assignee: Renesas Electronics Corporation

(21) Appl. No.: 13/347,436

(22) Filed: Jan. 10, 2012

(30) Foreign Application Priority Data
Jan. 26, 2011 (JP) 2011-013929

(51) Int. Cl. G06F 9/45

(52) U.S. Cl. 703/22

(57) ABSTRACT

Disclosed is a simulation device capable of simulating a functional IP with high accuracy. The simulation device includes a first CPU that controls the functional IP by executing a user program, a second CPU that simulates the functional IP by executing a simulator program, and a shared memory that is accessed by the first and second CPUs. In the shared memory, a built-in register area corresponding to a built-in register of the functional IP is mapped. The first CPU writes data into the built-in register area to control the simulation to be performed by the second CPU. The second CPU simulates the functional IP in accordance with the data written in the built-in register area. Consequently, the functional IP can be simulated with high accuracy.

### CROSS-REFERENCE TO RELATED APPLICATIONS

The disclosure of Japanese Patent Application No. 2011-13929 field on Jan. 26, 2011 including the specification, drawings, and abstract is incorporated herein by reference in its entirety.

### BACKGROUND

The present invention relates to a technology for simulating hardware mounted in a semiconductor device, and more particularly to a simulation device, simulation method, and computer program for efficiently simulating a specific-purpose functional block (IP) in an SoC (System on Chip).

With the recent advance of semiconductor device miniaturization technologies, the SoC is developed. The SoC is a chip incorporating, for instance, a CPU (Central Processing Unit), a memory, and a specific-purpose hardware logic, and widely used, for instance, for a media process that particularly processes a large amount of stream data.

In the above application, sufficient processing performance cannot be delivered by a microprocessor in the SoC. Therefore, a specific-purpose hardware logic circuit is mounted in the SoC as a functional block (IP) to increase the speed of processing. Desired processing capabilities and performance characteristics are often provided by allowing the microprocessor to control one or more functional blocks.

Inventions disclosed in Japanese Unexamined Patent Publications No. 2010-102496, 2005-044129, 2010-015534, and 2005-292912 relate to simulation method for the development of an IP to be mounted in the above-described SoC.

The invention disclosed in Japanese Unexamined Patent Publication No. 2010-102496 aims to obtain a system simulation device that ensures, when a program is to be executed in a hybrid manner on a host native and an ISS (Instruction Set Simulator), that a machine language program executable on a target system can be executed on the ISS. The ISS executes a target ISA (Instruction Set Architecture) of a target program. A bus simulator includes an address conversion table. When the target program running on the ISS gains memory access to global data through the bus simulator, the ISS acquires the address of the global data existing in an address space on a host computer by using the address conversion table and gains memory access to the global data on the host computer.

The invention disclosed in Japanese Unexamined Patent Publication No. 2005-044129 aims to achieve high-speed simulation without requiring many man-hours. An LSI development device includes a performance calculator and a performance evaluator. The performance calculator creates unit-process-specific files that describe predefined performance delivered when all unit processes, which are obtained by dividing a process incorporated in a system LSI into execution units, are executed by software, and predefined performance delivered when all the unit processes are executed by hardware. The performance evaluator evaluates the performance of the system LSI in accordance with the process performance of each unit process derived from the files.

The invention disclosed in Japanese Unexamined Patent Publication No. 2010-015534 relates to a method and device for developing a multi-core microcomputer system, and simulates a multi-core controller model having at least one parameter while at the same time simulating a device model that has at least one parameter and is controlled by the controller model. A user interface accesses the parameters of the controller model and device model to selectively suspend the executions of the controller model and device model in accordance with a trigger event. The user interface determines the states of various parameters of each core of the controller model and the parameters of the device model without changing the parameters of the controller model and device model at the time of trigging. A display device displays the determined parameters of both cores.

The invention disclosed in Japanese Unexamined Patent Publication No. 2005-292912 aims to provide a simulation device that is capable of emulating I/O operations with one CPU module in a multi-CPU programmable controller and performing debugging in a substantially practical manner while running an actual ladder program without an I/O module or an externally coupled item. The emulation CPU module includes an emulation I/O processor and an I/O memory. The emulation I/O processor is capable of processing an I/O module access from a sequence CPU module, which is another CPU module for simulation, as an access within a local CPU. The I/O memory stores not only a data table equivalent to an I/O module provided each for a plurality of CPU modules in accordance with pre-registered I/O information, but also a scheme for running a program for emulating I/O module operations.

### SUMMARY

Japanese Unexamined Patent Publications No. 2010-102496 and 2005-044129 relate to a method that executes a model simulator configured on a general-purpose PC (Personal Computer). In this model simulator, all hardware behaviors are described by software so that simulation can be performed on a general-purpose PC.

When the above technology is used, behaviors can be freely described by software. Therefore, a simulator can be developed by describing the behaviors of operations of a novel IP. However, when the IP is mounted in an SoC, it needs to cooperate with an existing CPU and existing peripheral I/O devices. Thus, all such existing modules need to be operated as a simulator. Consequently, it is difficult to develop the software for a system including such external modules by using a developed model simulator only.

Further, there is a prototype environment in addition to a simulation environment that uses the above-described model simulator. In the prototype environment, an RTL (Register Transfer Language) for actual hardware design is installed in an FPGA (Field Programmable Gate Array) to verify its operation.

In the above environment, actual operations of the modules including the peripheral I/O devices can be verified. Therefore, software development can be carried out in an environment similar to that of an actual LSI. However, the required development is more similar to hardware design. Therefore, when this is to be applied to a novel IP, more man-hours are required to develop the novel IP. Thus, when feedback needs to be provided for hardware, the period of development will increase because of changes to be applied to its architecture.

Furthermore, a system LSI (Large Scale Integrated circuit) formed by mounting a plurality of CPUs in an SoC has been developed in recent years. When desired performance requirements can be met, a function equivalent to that of a functional IP can be implemented by allowing one or more CPUs to execute a user program. The inventions disclosed in Japanese Unexamined Patent Publications No. 2010-015534 and 2005-292912 can be cited as the examples of the above-described multi-core simulation device.

The invention disclosed in Japanese Unexamined Patent Publication No. 2010-015534 uses a plurality of CPUs to configure a controller model and simulator, and selectively accesses the controller model and simulator from a user interface to perform simulation. This configuration can perform highly accurate simulation as it assigns a function of a functional IP to the CPUs and uses a peripheral function of an actual bus system, which is coupled to the CPUs, as a peripheral function other than the function of the functional IP. However, as the simulator is controlled from the user interface, a user program running on the CPUs, which actually control the functional IP, cannot be used as is by a developed SoC.

The invention disclosed in Japanese Unexamined Patent Publication No. 2005-292912 provides a simulation device that includes an emulation processor and an emulation module. The emulation processor processes an access to a simulation target. The emulation module includes a dedicated system program and a memory, and operates as a functional IP. However, although the same configuration as that of a functional IP is formed by the emulation module, one or more CPUs forming a multi-core configuration need to be configured as the above-described dedicated emulation module. Therefore, an SoC having such a configuration needs to be designed and prepared as a dedicated SoC for the simulation device.

The present invention has been made to address the above problems and provides a simulation device, simulation method, and computer program that are capable of performing highly accurate simulation of a functional IP.

According to an embodiment of the present invention, there is provided a simulation device for simulating a functional block to be developed. The simulation device includes a first processor, a second processor, and a shared memory. The first processor controls a functional IP by executing a user program. The second processor simulates the functional IP by executing a simulator program. The first and second processors access the shared memory. A built-in register area, which corresponds to a built-in register of the functional IP, is mapped in the shared memory. The first processor writes data into the built-in register area to control the simulation to be performed by the second processor. The second processor simulates the functional IP in accordance with the data written in the built-in register area.

According to an embodiment of the present invention, the second processor simulates the functional IP in accordance with the data written in the built-in register area. Therefore, the functional IP can be simulated with high accuracy.

### BRIEF DESCRIPTION OF THE DRAWINGS

Embodiments of the present invention will be described in detail based on the following figures, in which:

FIG. 1 is a diagram illustrating an example of a system applicable to the present invention;

FIG. 2 is a diagram illustrating an operation that is performed in an SoC 1 when a CPU 11 executes a user program 4;

FIG. 3 is a flowchart illustrating processing steps that are performed when the CPU 11 executes the user program 4;

FIG. 4 is a diagram illustrating an example of the system including a simulation device according to a first embodiment of the present invention;

FIG. 5 is a diagram illustrating in detail the configuration of an IP simulator;

FIG. 6 is a diagram illustrating in further detail simulator areas mapped in a shared memory 33;

FIG. 7 is a flowchart illustrating an operation of the system including the simulation device according to an embodiment of the present invention;

FIG. 8 is a diagram illustrating an operation that is performed in the SoC 1 when CPU 0 (31) and CPU 1 (32) execute a user program 7 and a simulator program 6;

FIG. 9 is a flowchart illustrating in further detail data arithmetic processing that is depicted in the flowchart of FIG. 7;

FIG. 10 is a diagram illustrating an operation that is performed by the SoC 1 when the IP simulator performs the data arithmetic processing;

FIG. 11 is a flowchart illustrating in further detail data transfer processing that is depicted in the flowchart of FIG. 7;

FIG. 12 is a diagram illustrating an operation that is performed by the SoC 1 when the IP simulator performs the data transfer processing; and

FIG. 13 is a diagram illustrating an example of the system including the simulation device according to a second embodiment of the present invention.

### DETAILED DESCRIPTION

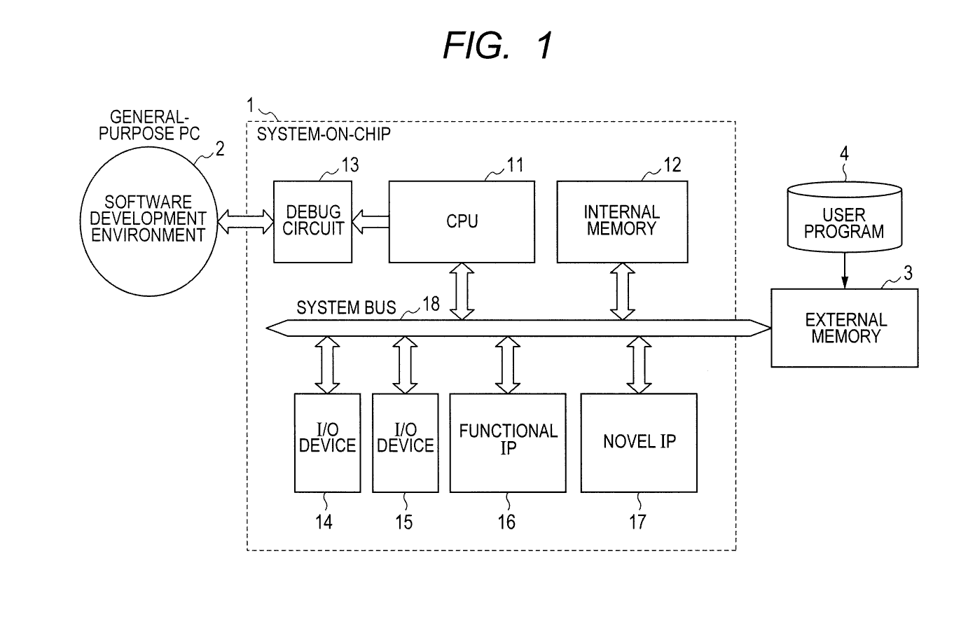

FIG. 1 is a diagram illustrating an example of a system applicable to the present invention. The system includes a system-on-chip (SoC) 1, a general-purpose PC 2, and an external memory 3. The general-purpose PC 2 provides a software development environment. The external memory 3 stores a user program 4.

The SoC 1 includes a CPU 11, an internal memory 12, a debug circuit 13, peripheral I/O devices 14, 15, a functional IP 16, and a novel IP 17 to be developed. The CPU 11, the internal memory 12, the external memory 3, the peripheral I/O devices 14, 15, the functional IP 16, and the novel IP 17 are intercoupled through a system bus 18.

The debug circuit 13 causes the CPU 11 to execute the user program in accordance with an instruction received from the general-purpose PC 2, which provides the software development environment.

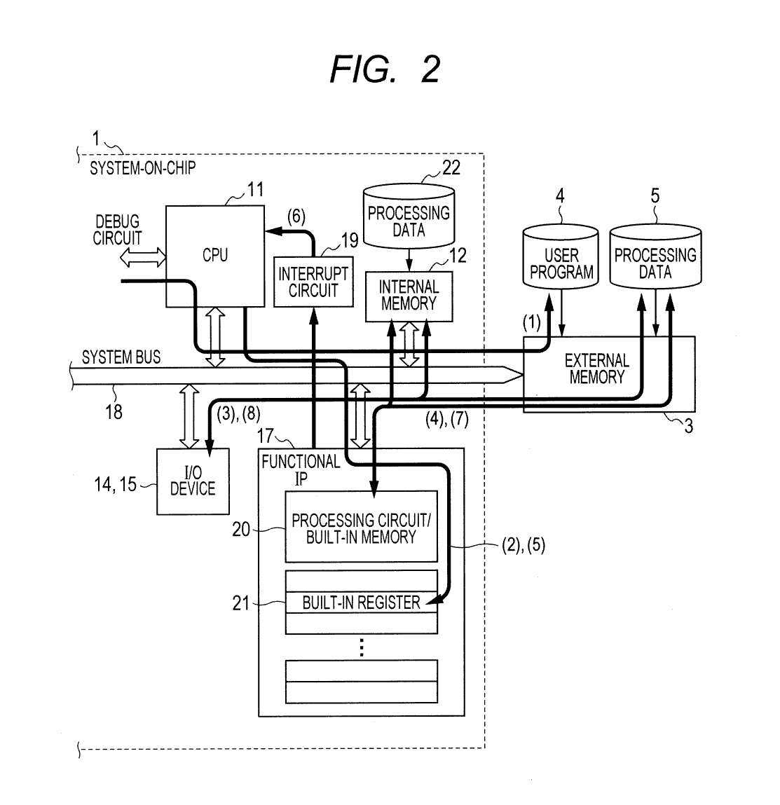

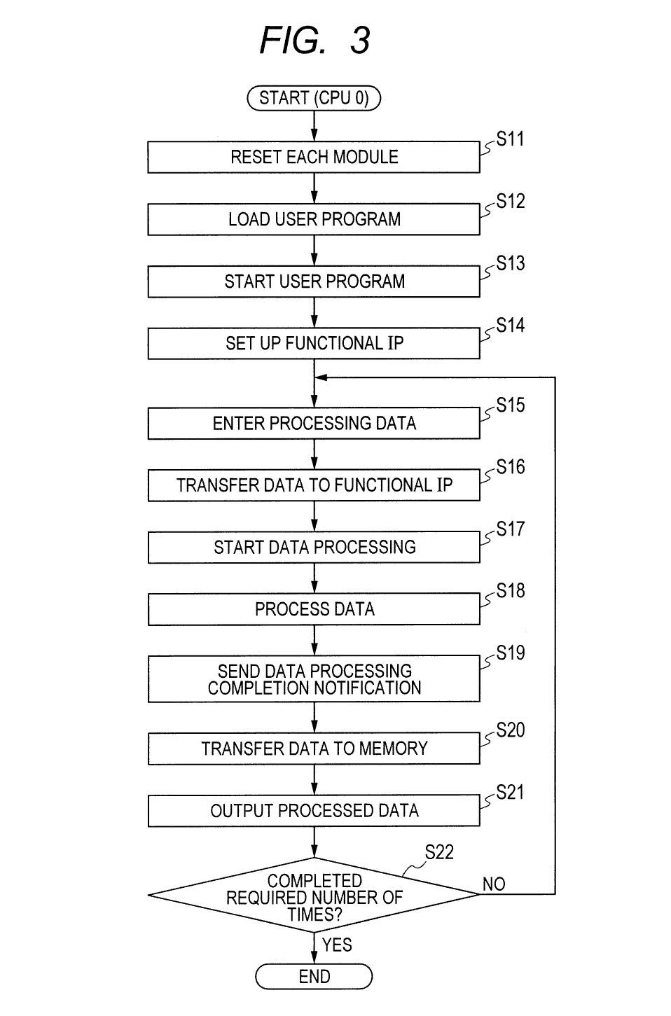

FIG. 2 is a diagram illustrating an operation that is performed in the SoC 1 when the CPU 11 executes the user program 4. FIG. 3 is a flowchart illustrating processing steps that are performed when the CPU 11 executes the user program 4. An operation performed by the system will now be described with reference to FIGS. 2 and 3.

First of all, each module in the SoC 1 is reset (step S11). The user program 4 is then loaded into the external memory 3 (step S12, (1) in FIG. 2). The user program 4 may be transferred from the general-purpose PC 2 to the external memory 3 or from an external storage device (not shown) to the external memory 3.

Next, when a user instructs the debug circuit 13 through the general-purpose PC 2 to start executing the user program 4, the CPU 11 starts executing the user program 4 in accordance with an instruction from the debug circuit 13 (step S13).

When the CPU 11 starts executing the user program 4, the novel IP 17 is set up, for instance, by initializing a built-in register 21 in the novel IP (functional IP) 17 and writing parameters (step S14, (2) in FIG. 2). Embodiments of the present invention use so-called memory mapped I/O, in which registers such as the built-in register 21 are mapped on a memory map.

Next, the CPU 11 reads processing target data (processing data 5) from the outside of the SoC 1 through the peripheral I/O device 14 or the peripheral I/O device 15, which are coupled to the system bus 18, and stores the read processing data 5 in the external memory 3 or the internal memory 12 (step S15, (3) in FIG. 2).

If, for instance, the SoC 1 is to perform image processing, image data picked up by a camera is stored into the external memory 3 or the internal memory 12 through a camera interface or other peripheral I/O device.

Next, the CPU 11 transfers the processing data 5 from the external memory 3 or the internal memory 12 to a line buffer or other built-in memory 20 of the functional IP 17 for the purpose of allowing the functional IP 17 to perform a process (step S16, (4) in FIG. 2).

Upon completion of the transfer of the processing data 5, the functional IP 17 becomes ready to perform its process. Therefore, the CPU 11 writes a startup signal into a startup register in the built-in register 21 within the functional IP 17 to let the functional IP 17 initiate its process (step S17, (5) in FIG. 2).

The functional IP 17 performs data processing and stores the result of processing in the built-in memory 20 (step S18). Upon completion of data processing, the functional IP 17 notifies the CPU 11 that data processing is completed (step S19, (6) in FIG. 2). This notification may be achieved by allowing the functional IP 17 to output an interrupt request to the CPU 11 through an interrupt circuit 19 or by preparing an execution status register in the built-in register 21 in the functional IP 17 and letting the CPU 11 periodically poll the execution status register to detect the completion of processing.

Upon receipt of a processing completion notification from the functional IP 17, the CPU 11 transfers processing result data from the built-in memory 20 of the functional IP 17 to the external memory 3 or the internal memory 12 (step S20, (7) in FIG. 2).

Next, the processing result data stored in the external memory 3 or the internal memory 12 is output to the outside through the peripheral I/O device 14 or the peripheral I/O device 15 (step S21, (8) in FIG. 2). Next, step S22 is performed to judge whether the functional IP 17 has performed its process a required number of times. If the functional IP 17 has not performed its process the required number of times (if the answer in step S22 is “NO”), the process returns to step S15 and repeats the subsequent steps. If, on the other hand, the functional IP 17 has performed its process the required number of times (if the answer in step S22 is “YES”), the process terminates.

As described above, when the novel IP 17 is to be developed and incorporated into the SoC 1, it is necessary to develop not only hardware logic to be incorporated into the SoC 1, but also software such as a driver for controlling the functional IP 17 from the CPU 11 in order to use the functional IP 17, which corresponds to the user program 4, an application using the functional IP 17, and middleware.

Further, the results of such software development can be fed back into the specifications for the hardware logic by making an early analysis of the degree of processing speed increase provided by the use of the developed novel IP 17 and by analyzing the amount of system bus data transfer required for the novel IP 17. This makes it possible to achieve novel IP development and system design with increased efficiency.

### FIRST EMBODIMENT

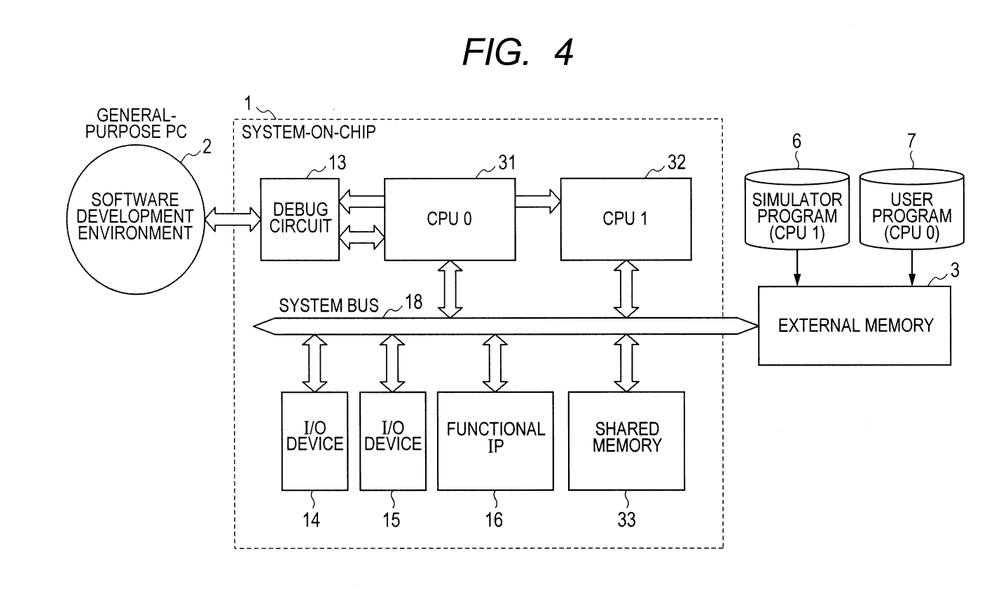

FIG. 4 is a diagram illustrating an example of the system including a simulation device according to a first embodiment of the present invention. The system includes the SoC 1, the general-purpose PC 2, and the external memory 3. The general-purpose PC 2 provides a software development environment. The external memory 3 stores a simulator program (CPU 1) 6 and a user program (CPU 0) 7.

The SoC 1 includes the debug circuit 13, the peripheral I/O devices 14, 15, the functional IP 16, CPU 0 (31), CPU 1 (32), and a shared memory 33. CPU 0 (31), CPU 1 (32), the shared memory 33, the external memory 3, the peripheral I/O devices 14, 15, and the functional IP 16 are intercoupled through the system bus 18. System components having the same configuration and function as those shown in FIG. 1 are designated by the same reference numerals as those used in FIG. 1.

In the system according to the present embodiment, it is assumed that CPU 1 (32), the shared memory 33, and the simulator program 6 emulate the function of the novel IP 17 shown in FIG. 2 and form an IP simulator.

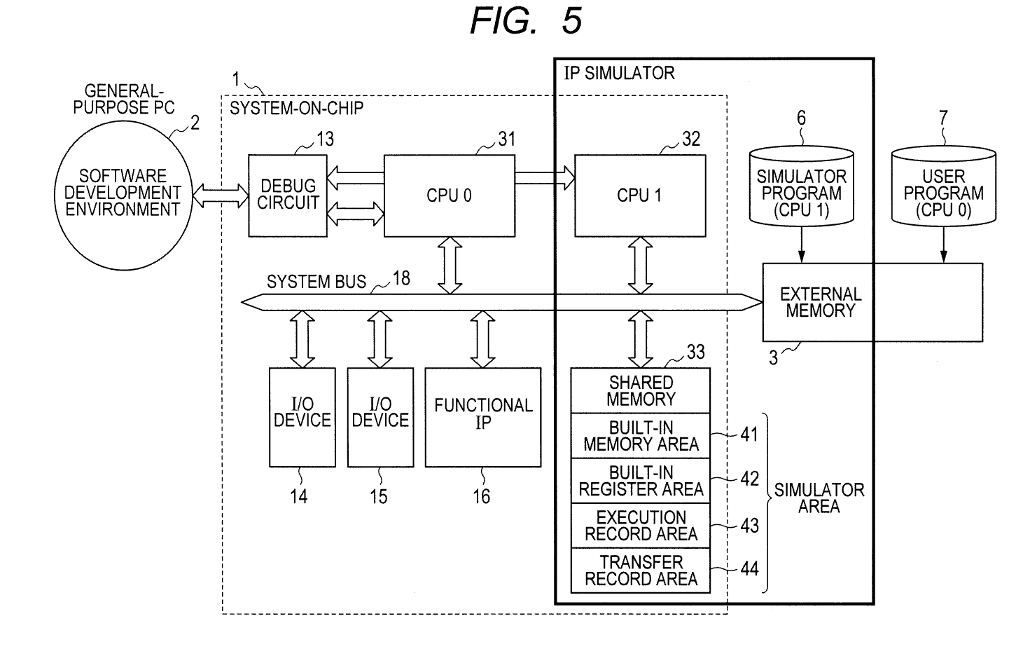

FIG. 5 is a diagram illustrating in detail the configuration of the IP simulator. CPU 0 (31) is assigned as a target CPU that runs the user program 7. CPU 1 (32) is assigned as a simulator CPU that runs the simulator program 6.

Four areas are mapped in the shared memory 33 as simulator areas. The four simulator areas are a built-in memory area 41 corresponding to the built-in memory 20 of the novel IP 17, a built-in register area 42 corresponding to the built-in register 21, an execution record area 43 for measuring and recording the number of arithmetic process execution cycles, and a transfer record area 44 for measuring and recording the number of data transfer cycles and the amount of data transfer.

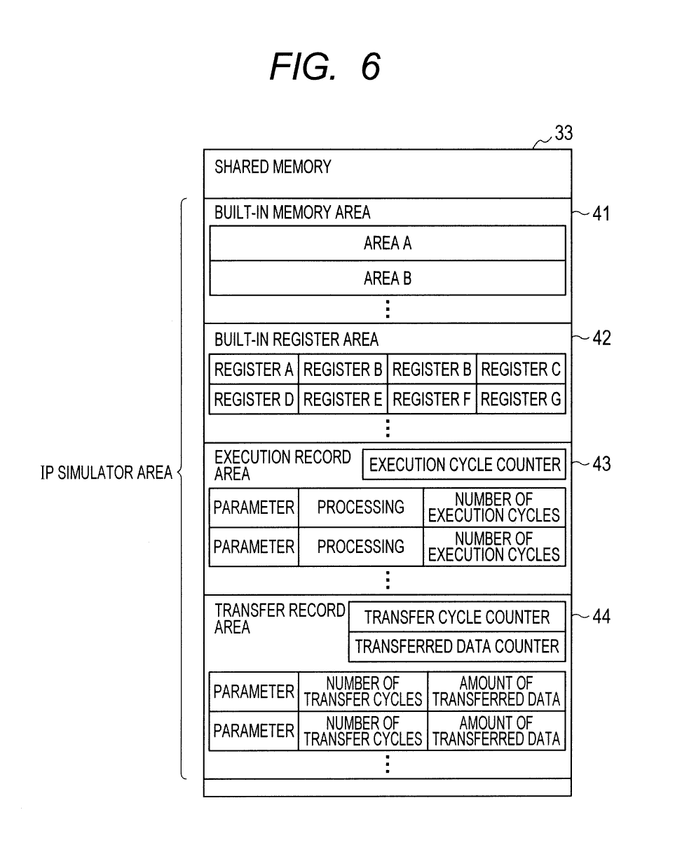

FIG. 6 is a diagram illustrating in further detail the simulator areas mapped in the shared memory 33. In the built-in memory area 41, memory areas built in, for instance, as a line buffer and data buffer for the novel IP 17 are mapped.

In the built-in register area 42, all built-in registers implemented for the novel IP 17 are mapped. In this instance, the built-in registers are mapped with their relative addresses maintained. This ensures that a control target can be changed from the hardware logic to the IP simulator or from the IP simulator to the hardware logic simply by changing only the base address of the novel IP 17 used by the user program 7.

The built-in registers to be mapped include, but are not limited to, a register for setting the parameters for the novel IP 17, a startup register for starting an arithmetic operation or a data transfer operation, and a status register for indicating the execution status of the novel IP 17.

These registers are not only referenced and written into by CPU 0 (31) in which the user program 7 runs, but also similarly referenced and written into by CPU 1 (32) in which the simulator program 6 runs.

A shared memory coupled to a system bus within a multi-core configuration generally has a snoop function for controlling the consistency of data written by a plurality of CPU cores. Therefore, insignificant software limitations are imposed on the implementation of the simulator program 6.

In the execution record area 43, one or more execution cycle counters and a trace buffer are mapped. Each execution cycle counter counts the number of arithmetic process execution cycles during an operation. The trace buffer records an execution result together with parameters such as simulation time and execution point, a process description, and the number of execution cycles.

As regards the execution result, the number of executions is enormous due to simulation. Therefore, the simulator program 6 can copy the execution result from the shared memory 33 and store the copied execution result in the external memory 3. Further, as the execution result is mapped in the shared memory 33, this processing result can be referenced from the general-purpose PC (software development environment) 2. Therefore, performance analysis can be made in accordance with the number of execution cycles.

In the transfer record area 44, a transfer cycle counter and a transfer data counter are mapped. The transfer cycle counter counts the number of data transfer cycles. The transfer data counter counts the amount of transferred data for load analysis of the system bus 18. In addition, an area for recording data transfer parameters, the number of transfer cycles, and the amount of transferred data is also mapped in the transfer record area 44.

As the number of transfer cycles and the amount of transferred data are mapped in the shared memory 33, these data can be referenced from the general-purpose PC (software development environment) 2. Therefore, load analysis can be made in accordance with the transferred data.

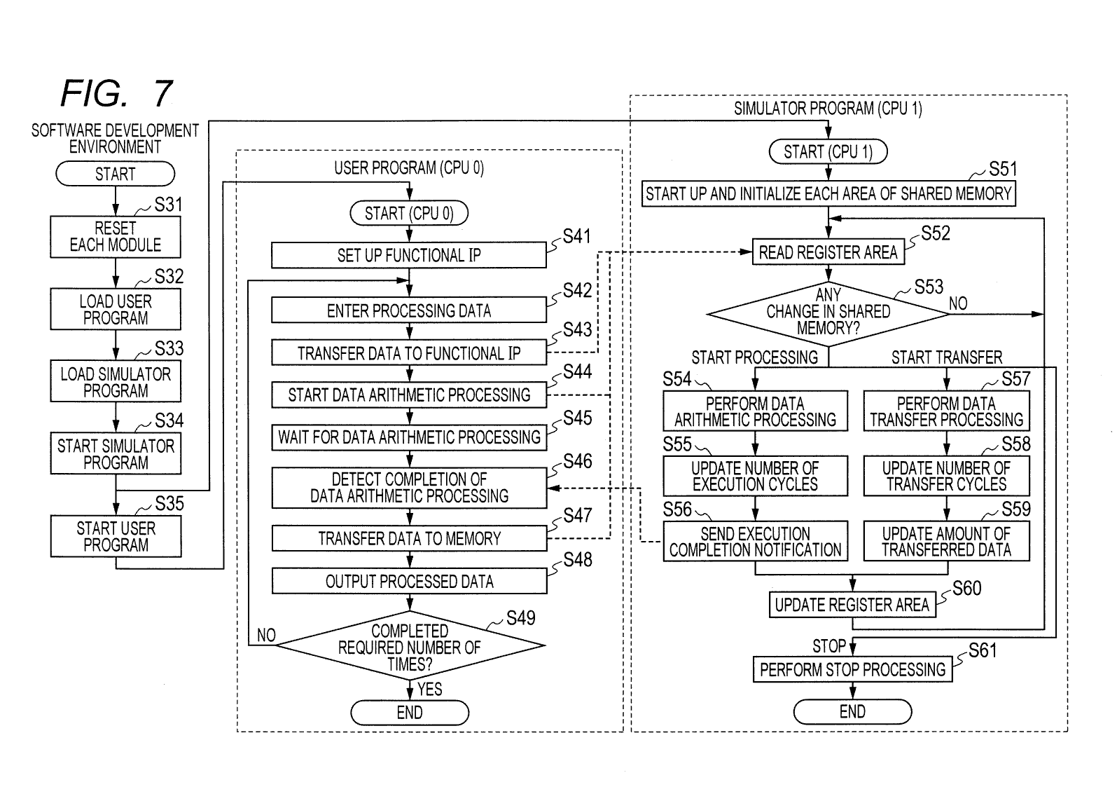

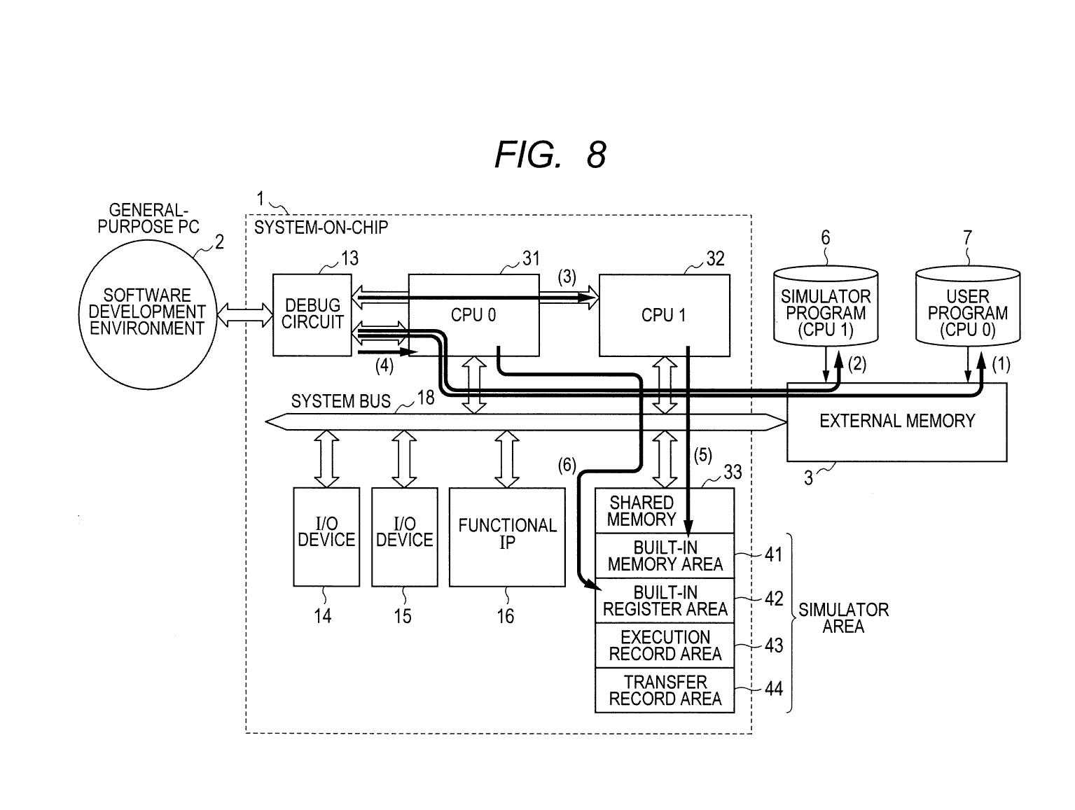

FIG. 7 is a flowchart illustrating an operation of the system including the simulation device according to an embodiment of the present invention. FIG. 8 is a diagram illustrating an operation that is performed in the SoC 1 when CPU 0 (31) and CPU 1 (32) execute the user program 7 and the simulator program 6. The operation of the system including the simulation device will be described below with reference to FIGS. 7 and 8.

In the flowchart of FIG. 7, steps S31 to S35 are performed by the general-purpose PC (software development environment); steps S41 to S49 are performed by CPU 0 (31) in which the user program 7 runs; and steps S51 to S61 are performed by CPU 1 (32) in which the simulator program 6 runs.

First of all, each module in the SoC 1 is reset (step S31). The user program 7 is then loaded into the external memory 3 (step S32, (1) in FIG. 8). Next, the simulator program 6 is loaded into the external memory 3 (step S33, (2) in FIG. 8).

Next, when the user instructs the debug circuit 13 through the general-purpose PC 2 to start executing the simulator program 6, CPU 1 (32) starts executing the simulator program 6 in accordance with an instruction from the debug circuit 13 (step S34, (3) in FIG. 8).

In the above instance, CPU 1 (32) starts executing the simulator program 6, initializes each area of the shared memory 33 (step S51, (5) in FIG. 8), references the contents of the built-in register area 42 (step S52), and judges whether the contents of the built-in register area 42 are changed, that is, performs polling at regular intervals (step S53). In this manner, CPU 1 (32) enters a ready-to-run state and operates as an IP simulator that performs the same operation as the novel IP 17.

When the general-purpose PC 2 instructs the debug circuit 13 to start executing the user program 7 after IP simulator startup, CPU 0 (31) starts executing the user program 7 in accordance with an instruction from the debug circuit 13 (step S35, (4) in FIG. 8).

In the above instance, as the IP simulator is already operating, CPU 0 (31) performs the same steps as steps S14 to S22 in the flowchart of FIG. 3. More specifically, when CPU 0 (31) starts executing the user program 7, it operates, for instance, to initialize the built-in register area 42 of the shared memory 33 and write parameters in the same manner as for setting up the novel IP (functional IP) 17 (step S41, (6) in FIG. 8).

Next, CPU 0 (31) reads processing target data from the outside of the SoC 1 through the peripheral I/O device 14 or peripheral I/O device 15 coupled to the system bus 18, and stores the read processing target data in the external memory 3 (step S42).

Next, CPU 0 (31) transfers processing data from the external memory 3 to the built-in memory area 41 of the shared memory 33, such as a line buffer, in order to let the IP simulator perform the data arithmetic processing (step S43). In this instance, CPU 0 (31) performs a process of transferring data to the IP simulator. The details of such a process will be described later.

Upon completion of processing data transfer, the IP simulator becomes ready to perform the data arithmetic processing. Therefore, CPU 0 (31) writes a startup signal in a startup register in the built-in register area 42 of the shared memory 33 to let the IP simulator initiate the data arithmetic processing (step S44). CPU 0 (31) then waits for the IP simulator to perform the data arithmetic processing (step S45).

When the IP simulator completes the data arithmetic processing, CPU 0 (31) receives a notification from the IP simulator to detect the completion of the data arithmetic processing (step S46), and transfers processing result data from the built-in memory area 41 of the shared memory 33 to the external memory 3 (step S47). In this instance, CPU 0 (31) performs a process of transferring data to the IP simulator. The details of such a process will be described later.

Next, the processing result data stored in the external memory 3 is output to the outside through the peripheral I/O device 14 or peripheral I/O device 15 (step S48). Step S49 is then performed to judge whether the IP simulator has performed its process a required number of times. If the IP simulator has not performed its process the required number of times (if the answer in step S49 is “NO”), the process returns to step S42 and repeats the subsequent steps. If, on the other hand, the IP simulator has performed its process the required number of times (if the answer in step S49 is “YES”), the process terminates.

As described earlier, CPU 1 (32) performs polling after IP simulator startup to judge whether the contents of the built-in register area 42 are changed (step S53). If CPU 0 (31) has written into the built-in register area 42, CPU 1 performs the data arithmetic processing, data transfer processing, or stop processing in accordance with the contents of the built-in register area 42.

If an instruction for starting the data arithmetic processing is written in the built-in register area 42 (if the answer in step S53 is “START PROCESSING”), CPU 1 (32) performs the later-described data arithmetic processing (step S54). Next, CPU 1 (32) updates the number of execution cycles by increasing the number of execution cycles in accordance with the data arithmetic processing (step S55), and notifies CPU 0 (31) of the completion of data processing (step S56). Next, CPU 1 (32) updates the contents of the built-in register area 42 (step S60), returns to step S52, and repeats the subsequent steps.

If an instruction for starting the data transfer processing is written in the built-in register area 42 (if the answer in step S53 is “START TRANSFER”), CPU 1 (32) performs the later-described data transfer processing (step S57). Next, CPU 1 (32) updates the number of transfer cycles by increasing the number of transfer cycles in accordance with the data transfer processing (step S58), and updates the amount of transferred data by increasing the amount of transferred data in accordance with the data transfer processing (step S59). Next, CPU 1 (32) updates the contents of the built-in register area 42 (step S60), returns to step S52, and repeats the subsequent steps.

If an instruction for stopping a process is written in the built-in register area 42 (if the answer in step S53 is “STOP”), CPU 1 (32) terminates the process.

The IP simulator operations described in the flowchart of FIG. 7 are an arithmetic processing operation, a data transfer operation, and a stop operation. However, all these operations comply with the specifications for the functional IP 17, which provides the hardware logic, and the IP simulator operations are not limited to these operations.

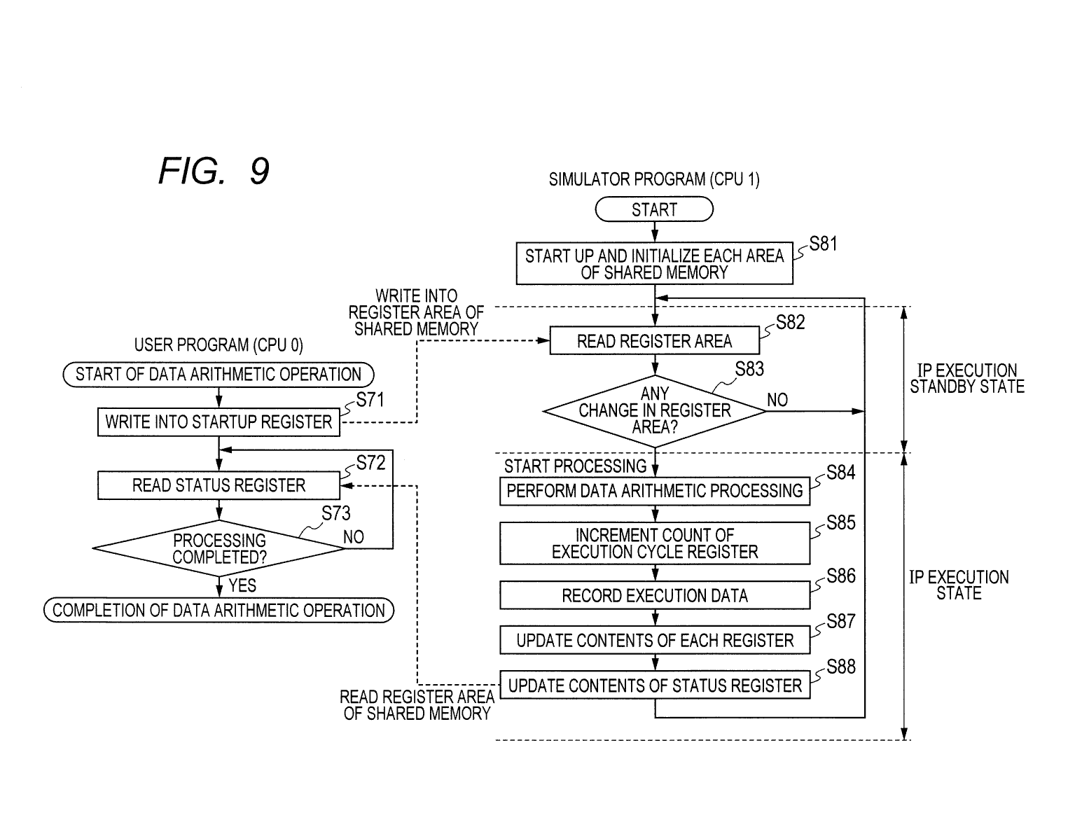

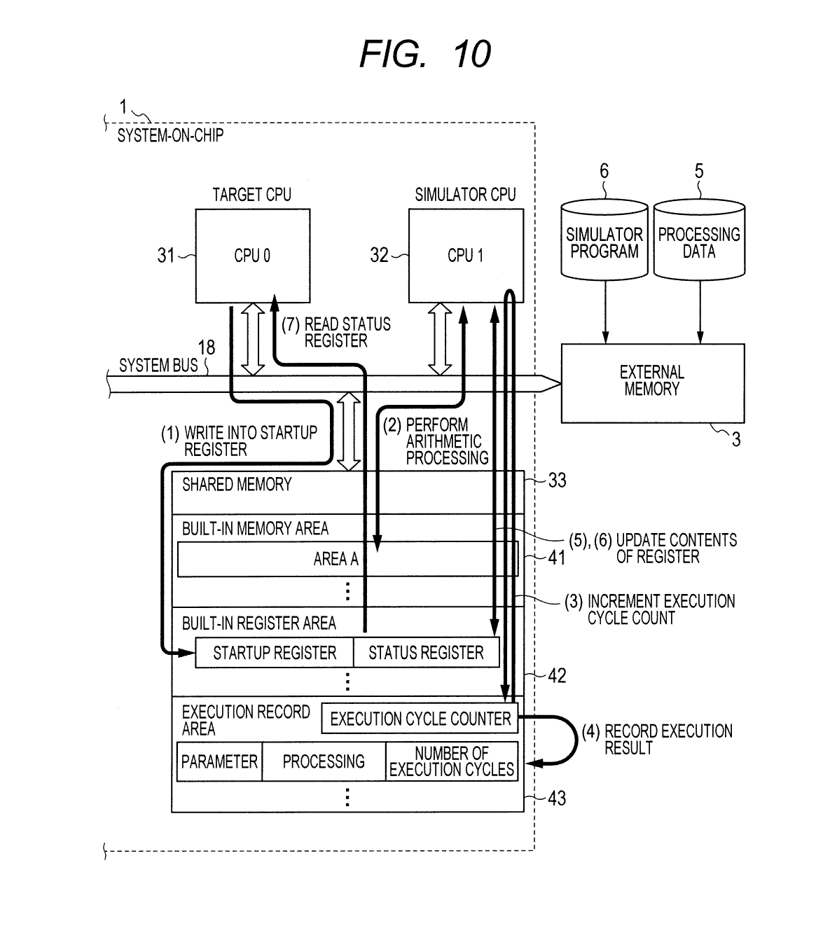

FIG. 9 is a flowchart illustrating in further detail the data arithmetic processing that is depicted in the flowchart of FIG. 7. FIG. 10 is a diagram illustrating an operation that is performed by the SoC 1 when the IP simulator performs the data arithmetic processing. A data arithmetic processing operation will be described below with reference to FIGS. 9 and 10.

As described earlier, CPU 1 (32) starts executing the simulator program 6 to initialize each area of the shared memory 33 (step S81), and polls the contents of the built-in register area 42 (steps S82 and S83) to enter the ready-to-run state.

When CPU 0 (31) writes a startup signal in an area in the built-in register area 42 that corresponds to a startup register (step S71, (1) in FIG. 10), the IP simulator starts performing the data arithmetic processing. In this instance, the data arithmetic processing can be performed because data necessary for arithmetic processing is already transferred to a line buffer and a data buffer, which are within the built-memory area 41.

When CPU 1 (32) detects that CPU 0 (31) has written into the startup register, and the resulting change in the startup register indicates the start of data arithmetic processing (if the answer in step S83 is “START PROCESSING”), CPU 1 (32) starts performing a data arithmetic operation. CPU 1 (32) performs arithmetic processing on data stored in the built-in memory area 41 of the shared memory 33, and stores the result of arithmetic processing in the built-in memory area 41 that corresponds to an output area (step S84, (2) in FIG. 10).

In the above instance, CPU 1 (32) uses the execution cycle counter to count the number of execution cycles in the functional IP 17 in accordance with the executed data arithmetic processing (step S85), and performs a write-back operation to add the counted number of execution cycles to a value in an execution cycle count record area within the execution record area 43 (step S86, (4) in FIG. 10). If necessary, CPU 1 (32) stores statistical information, such as the relevant simulation time, execution point, and process description, in the execution record area 43 as an execution data record. The number of execution cycles in the functional IP 17 is predefined for each type of arithmetic processing and added to calculate the actual number of execution cycles.

As described above, the number of execution cycles and the simulation time are recorded in the execution record area 43. Further, the general-purpose PC (software development environment) 2 references such recorded information after completion of data arithmetic processing. Therefore, the execution performance of the IP simulator can be estimated with high accuracy even if IP simulator execution time disagrees with actual hardware logic.

Next, CPU 1 (32) updates the contents of the registers such as the startup register (step S87, (5) in FIG. 10), updates the contents of the status register to complete the data arithmetic processing (step S88, (6) in FIG. 10), returns to step S82, and repeats the subsequent steps.

CPU 0 (31) references the status register (step S72) and judges whether the data arithmetic processing is completed (step S73). If the data arithmetic processing is not completed (if the answer in step S73 is “NO”), CPU 0 (31) returns to step S72 and repeats the subsequent steps. If, on the other hand, the data arithmetic processing is completed (if the answer in step S73 is “YES”), CPU 0 (31) terminates the data arithmetic operation.

Referring to FIG. 9, CPU 0 (31) detects the completion of data arithmetic processing by the IP simulator by polling the status register that records the execution status of the functional IP 17. Alternatively, however, an interrupt request can be issued to CPU 0 (31) as described earlier to notify CPU 0 (31) of the completion of data arithmetic processing. The method of such completion notification complies with the specifications for the functional IP 17 to be developed.

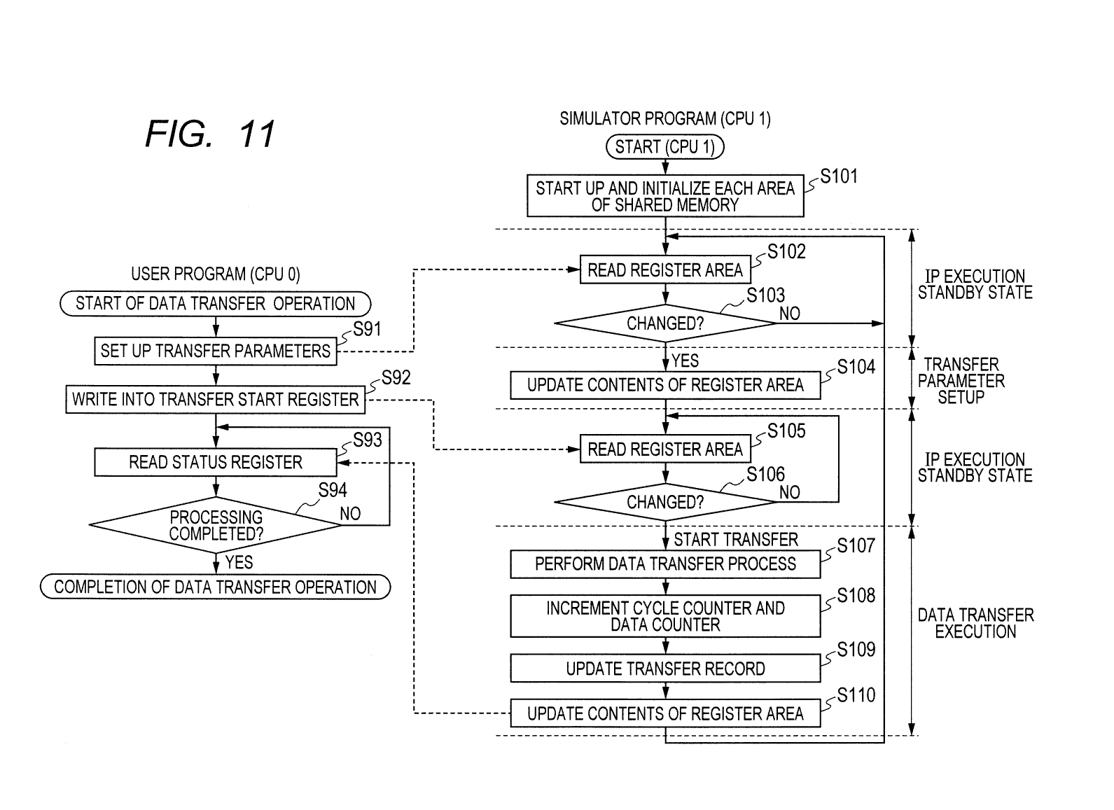

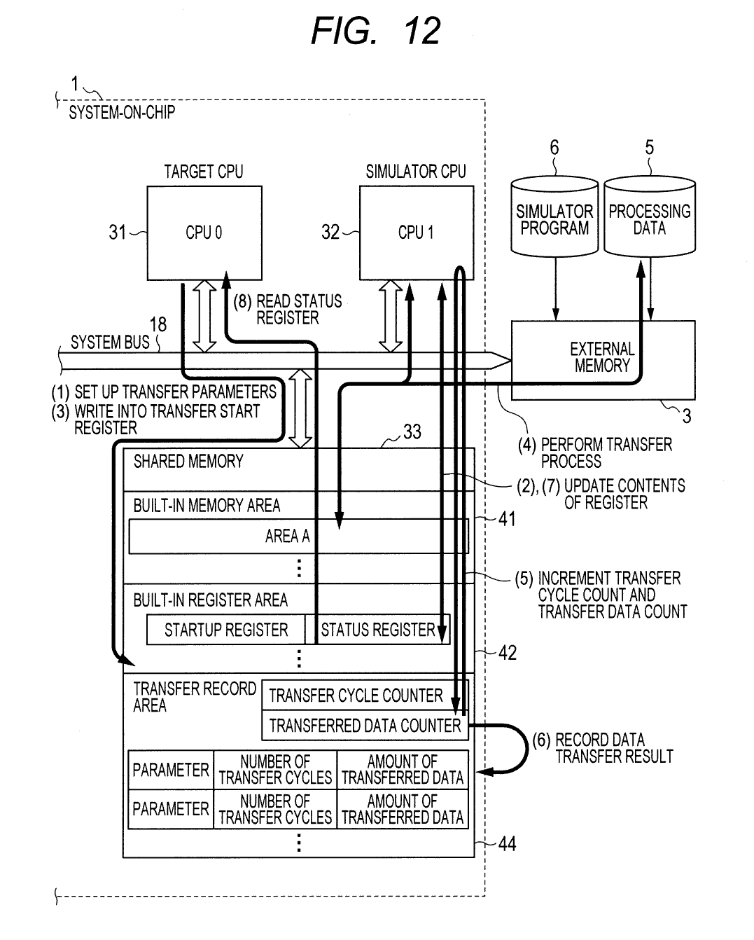

FIG. 11 is a flowchart illustrating in further detail the data transfer processing that is depicted in the flowchart of FIG. 7. FIG. 12 is a diagram illustrating an operation that is performed by the SoC 1 when the IP simulator performs the data transfer processing. A data transfer processing operation will be described below with reference to FIGS. 11 and 12.

As described earlier, CPU 1 (32) starts executing the simulator program 6 to initialize each area of the shared memory 33 (step S101), polls the contents of the built-in register area 42 (steps S102 and S103), and enters the ready-to-run state.

CPU 0 (31) sets in the built-in register area 42 transfer parameters required for data transfer, such as the number of data to be transferred, a transfer source address, a transfer destination address, and a data type (step S91, (1) in FIG. 12).

When CPU 1 (32) detects a change in the contents of the built-in register area 42 (if the answer in step S103 is “YES”), CPU 1 updates the internal state, for instance, of the status register that is affected by the contents of the built-in register area 42 (step S104, (2) in FIG. 12), polls again the contents of the built-in register area 42 (steps S105 and S106), and enters the ready-to-run state.

When CPU 0 (31) writes a startup signal in a transfer start register within the built-in register area 42 in the above state (step S92, (3) in FIG. 12), CPU 1 (32) starts the data transfer processing in accordance with the preset transfer parameters (step S107, (4) in FIG. 12).

If the data transfer processing is for a write into the built-in memory area 41, CPU 1 (32) reads transfer target data from a designated transfer source address in the external memory 3 and writes the transfer target data in a designated area within the built-in memory area 41 of the shared memory 33, such as a line buffer or a data buffer.

If, on the other hand, the data transfer processing is for a read from the built-in memory area 41, CPU 1 (32) reads data from a designated area within the built-in memory area 41 and writes the data at a designated transfer destination address in the external memory 3.

The above-described data transfer processing is performed in accordance with the parameters preset in the built-in register area 42 and repeated until a desired amount of data is completely transferred.

In the above instance, CPU 1 (32) uses the transfer cycle counter and transfer data counter to count the number of transfer cycles in the functional IP 17 and the amount of transferred data in accordance with the executed data transfer processing (step S108, (5) in FIG. 12), and performs a write-back operation to add the number of transfer cycles and the amount of transferred data to values in a transfer cycle count record area and transferred data amount record area within the transfer record area 44 (step S109, (6) in FIG. 12).

If necessary, CPU 1 (32) stores parameters, such as the relevant simulation time, execution point, type (read or write), and transfer mode, and statistical information, such as the number of transfer cycles and the amount of transferred data, in the transfer record area 44 as a transfer data record.

As described above, the number of transfer cycles, the amount of transferred data, and the simulation time are recorded in the transfer record area 44. Further, the general-purpose PC (software development environment) 2 references such recorded information after completion of data transfer. Therefore, the data transfer load on the system bus 18 and the data transfer time can be estimated with high accuracy even if IP simulator execution time disagrees with actual hardware logic.

When the data transfer processing is completed as desired, CPU 1 (32) updates the contents of each area within the built-in register area 42 as needed to represent the result of execution (step S110, (7) in FIG. 12), and notifies CPU 0 (31) of the completion of the execution.

CPU 0 (31) references the status register (step S93) and judges whether the data transfer processing is completed (step S94). If the data transfer processing is not completed (if the answer in step S94 is “NO”), CPU 0 (31) returns to step S93 and repeats the subsequent steps. If, on the other hand, the data transfer processing is completed (if the answer in step S94 is “YES”), CPU 0 (31) terminates the data transfer operation.

Referring to FIG. 11, CPU 0 (31) detects the completion of data transfer processing by the IP simulator by polling the status register that records the execution status of the functional IP 17. Alternatively, however, an interrupt request can be issued to CPU 0 (31) as described earlier to notify CPU 0 (31) of the completion of data transfer. The method of such completion notification complies with the specifications for the functional IP 17 to be developed.

As described above, the simulation device according to the present embodiment uses the IP simulator to implement the function of the functional IP to be developed, and uses actual hardware to represent, for example, the other existing modules, the target CPU in which the user program runs, and the system bus. Consequently, simulation can be performed with high accuracy.

Further, the built-in registers of the functional IP 17 are mapped in areas of the shared memory 33 that have the same relative address. Therefore, the same program can be used simply by changing the base address no matter whether the user program 7 controls the IP simulator or the functional IP 17.

Furthermore, the IP simulator records the number of execution cycles, the number of data transfer cycles, the amount of data transfer, and other relevant information in the execution record area 43 and transfer record area 44 provided in the shared memory 33. Therefore, the performance of the functional IP 17 and the load on the system bus 18 can be evaluated with high accuracy.

Moreover, as far as the SoC has a multi-CPU configuration and the shared memory is provided, the IP simulator can be implemented without regard to the hardware configuration, for instance, of the other modules. Hence, an existing LSI can be used as the IP simulator. This makes it possible to provide a low-cost, simulator-based software development environment without requiring a dedicated simulation device.

### SECOND EMBODIMENT

The simulation device according to the first embodiment is configured so that one CPU executes a simulator program to implement the IP simulator. On the other hand, the simulation device according to a second embodiment of the present invention is configured so that a plurality of CPUs execute simulator programs to implement the IP simulator.

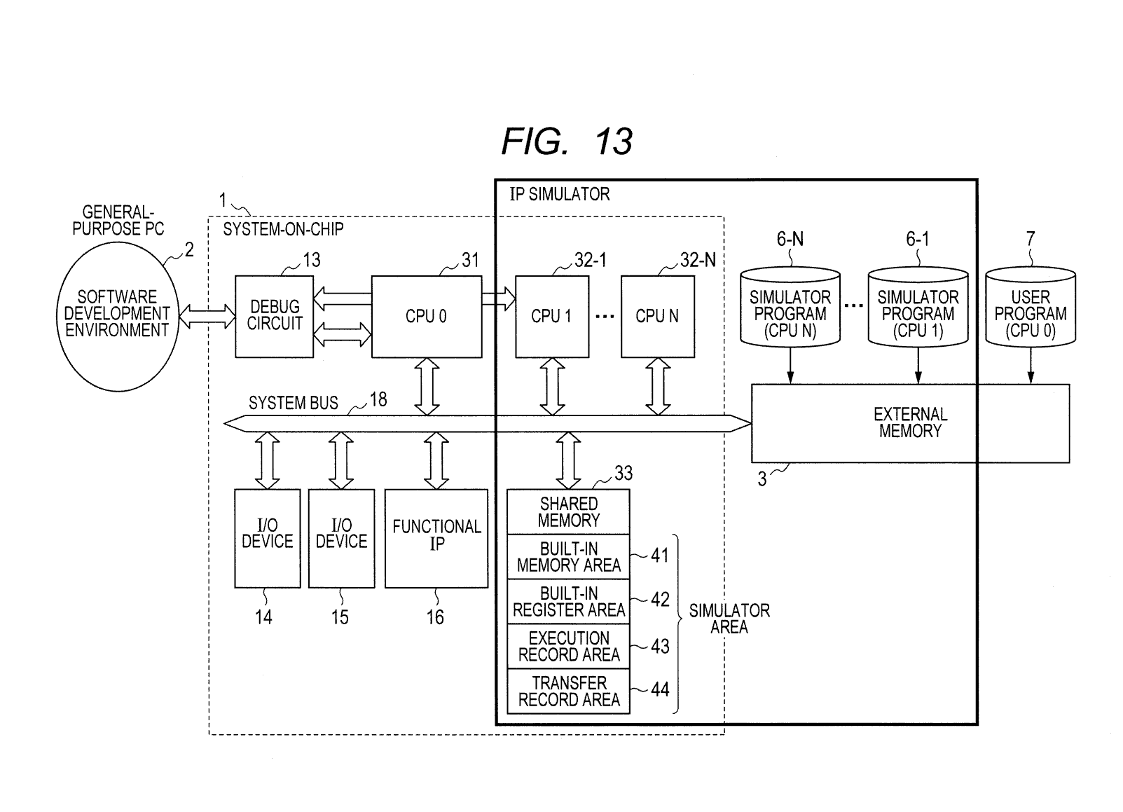

FIG. 13 is a diagram illustrating an example of the system including the simulation device according to the second embodiment of the present invention. The system includes the SoC 1, the general-purpose PC 2, and the external memory 3. The general-purpose PC 2 provides a software development environment. The external memory 3 stores simulator programs (CPU 1 to CPU N) 6-1 to 6-N and the user program (CPU 0) 7.

The SoC 1 includes the debug circuit 13, the peripheral I/O devices 14, 15, the functional IP 16, CPU 0 (31), CPUs 1 to N (32-1 to 32-N), and the shared memory 33. CPU 0 (31), CPUs 1 to N (32-1 to 32-N), the shared memory 33, the external memory 3, the peripheral I/O devices 14, 15, and the functional IP 16 are intercoupled through the system bus 18. System components having the same configuration and function as those shown in FIG. 5 are designated by the same reference numerals as those used in FIG. 5.

CPUs 1 to N (32-1 to 32-N) execute the simulator programs 6-1 to 6-N, respectively, to implement the IP simulator. In this instance, the data arithmetic processing is divided into two or more data arithmetic processings. The two or more arithmetic processings are executed by two or more CPUs to reduce the IP simulator execution time so that the resulting operation is more similar to the actual operation of the functional IP 17.

Even when the processing is divided and executed in parallel by the CPUs, the built-in memory area 41, the built-in register area 42, the execution record area 43, and the transfer record area 44 are mapped in the shared memory 33, as is the case with the IP simulator according to the first embodiment. Therefore, a program identical with the user program 7, which has been described in connection with the first embodiment, can be used in the second embodiment.

As described above, the simulation device according to the second embodiment divides the simulator program and allows the CPUs to execute the divided programs in parallel. Therefore, the simulation device according to the second embodiment not only provides the advantages described in connection with the first embodiment, but also reduces the IP simulator execution time and performs an operation more similar to the actual operation of the functional IP 17.

The above-described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A simulation device for simulating a functional block to be developed, the simulation device comprising:
a first processor that controls the functional block by executing a user program;
a second processor that simulates the functional block by executing a simulator program; and
a shared memory that is accessed by the first processor and the second processor,
wherein in the shared memory, a built-in register area corresponding to a built-in register of the functional block is mapped,
wherein the first processor writes data into the built-in register area to control the simulation to be performed by the second processor, and
wherein the second processor simulates the functional block in accordance with the data written in the built-in register area.

2. The simulation device according to claim 1, wherein the built-in register area is mapped in an area of the shared memory that agrees with the relative address of the built-in register of the functional block.

3. The simulation device according to claim 2,
wherein in the shared memory, a built-in memory area corresponding to a built-in memory of the functional block is additionally mapped, and
wherein when the first processor writes a data arithmetic processing request in the built-in register area, the second processor performs arithmetic processing on data stored in the built-in memory area.

4. The simulation device according to claim 3,
wherein in the shared memory, an execution record area for recording the number of execution cycles required for data arithmetic processing is mapped, and
wherein when performing the data arithmetic processing, the second processor calculates the number of execution cycles and stores the calculated number of execution cycles in the execution record area.

5. The simulation device according to claim 2,
wherein in the shared memory, the built-in memory area corresponding to the built-in memory of the functional block is additionally mapped, and
wherein when the first processor writes a data transfer processing request in the built-in register area, the second processor reads data from an external memory and transfers the data to the built-in memory area.

6. The simulation device according to claim 5, wherein when the first processor writes a data transfer processing request in the built-in register area, the second processor reads data from the built-in memory area and transfers the data to the external memory.

7. The simulation device according to claim 6,
wherein in the shared memory, a transfer record area for recording the number of transfer cycles required for data transfer and the amount of transferred data is additionally mapped, and
wherein when performing data transfer processing, the second processor calculates the number of transfer cycles and the amount of transferred data and stores the calculated values in the transfer record area.

8. The simulation device according to claim 1, further comprising:
a third processor that simulates the functional block,
wherein the simulator program is divided into at least two programs, and
wherein the second processor and the third processor execute the divided simulator programs.

9. A simulation method for simulating a functional block that is to be developed and incorporated into a system having a first processor, a second processor, and a shared memory, wherein in the shared memory, a built-in register area corresponding to a built-in register of the functional block is mapped, the simulation method comprising the steps of:
executing a user program, by the first processor, to write data into the built-in register area and control the simulation to be performed by the second processor; and
executing a simulator program, by the second processor, to simulate the functional block in accordance with the data written into the built-in register area.

10. A computer-readable storage medium storing a computer program for simulating a functional block that is to be developed and incorporated into a system having a first processor, a second processor, and a shared memory, the computer program comprising the steps of:
reading, by the second processor, processing results written by the first processor into a built-in register area corresponding to a built-in register of the functional block that is mapped in the shared memory; and
simulating, by the second processor, the functional block in accordance with the read processing results.
